(19) United States
(12) Patent Application Publication
(10) Pub. No.: US 2003/0075033 A1
(43) Pub. Date: Apr. 24, 2003

(54) Workpiece support accessory for table-mounted power saw

(76) Inventor: John David Speakman, Dallas, TX (US)

Correspondence Address: DENNIS T. GRIGGS, 17950 PRESTON ROAD, SUITE 1000, DALLAS, TX, 75252, US

(21) Appl. No.: 09/825,196

(22) Filed: Apr. 3, 2001

(51) Int. Cl. B26D 7/01

(52) U.S. Cl. 83/477.2; 83/471; 83/953

(57) ABSTRACT

A workpiece support accessory in the form of a sloping extension panel is coupled for pivotal and horizontal displacement relative to a table-mounted power saw for supporting oversized stock. When an oversized piece of stock is cut, the extension panel prevents the workpiece from inadvertently falling or twisting. A horizontal roller at the delivery end of the workpiece support accessory reduces the friction between the oversized stock and work surface allowing for easy movement during the saw operation. The operator can adjust the horizontal placement of the workpiece support accessory, the slope angle of the extended support surface, the elevation of the horizontal roller and the separation between the horizontal roller and the delivery end of the extension panel.

### BACKGROUND OF THE INVENTION

This invention relates generally to workpiece accessories for power tools, and in particular to extension tables for supporting a long workpiece that is being fed through a table saw.

Conventional table saws, radial arm saws and jig saws are mounted on a heavy bench or other support for convenient use. The bench provides a work surface for the workpiece to be cut and a mechanism for raising or lowering the saw blade through a slot relative to the work surface. That arrangement is convenient for most workpieces and sawing operations, but it will not safely accommodate a workpiece that extends substantially beyond the edge of the main work bench.

A serious problem occurs when the end of the workpiece unexpectedly falls or shifts. The workpiece can become twisted, changing the angle of the cutting plane and rendering the workpiece unusable. Even worse, an uncontrolled or unstable workpiece can endanger the operator.

Various kinds of extension tables are mountable on the delivery end of a table saw for supporting a workpiece as it is advanced across the cutting blade. In particular, U.S. Pat. No. 4,106,381 (Kreitz) entitled “Extension Table for Table Saws” discloses an extension table with a workpiece support surface mounted in coplanar relationship with the top of the table saw. The workpiece extension table is supported on a pair of legs, which have extendable, telescoping sections for height adjustment. A limitation on the Kreitz extension table is the excess friction created by the workpiece being in constant contact with the extension table surface. The operator must use additional force to overcome the excess friction and complete a saw operation.

U.S. Pat. No. 4,393,969 (Woell) entitled “Roller Table for Use with a Power Saw” discloses a workpiece support accessory in which multiple parallel rotors are supported on a frame that is attached to the delivery end of a table saw for supporting the leading end of a workpiece as it is advanced across the cutting blade. A limitation on the Woell roller table supporting arrangement is the large number of spaces or gaps between the rollers of the support surface. The workpiece may be damaged or the operator may be injured if the end of the workpiece becomes wedged between two rollers.

U.S. Pat. No. 4,753,279 (Harris) entitled “Stand for a Table Saw” shows a free-standing, adjustable height roller assembly that can be set up adjacent a table saw for supporting the leading end of a workpiece as it is advanced across the table saw. A limitation on the Harris stand is the large gap or space between the roller support and the table stand. As with the Woell roller table, the workpiece may be damaged or the operator may be injured if the workpiece falls between the roller support and the table stand.

U.S. Pat. No. 4,852,623 (Rodrigues) entitled “Extension Table for a Table Saw” discloses a roller support assembly that is pivotally attached to the end of a table saw for holding a cylindrical roller in a position for supporting a workpiece as it is advanced across the top of a table saw.

U.S. Pat. No. 5,462,102 (Searfoss) entitled “Adjustable Rolling Saw Stand” discloses a power saw stand including a support roller mounted on the feed end of the stand and another support roller mounted on the delivery end of the stand for supporting a workpiece as it is advanced across the table saw.

U.S. Pat. No. 3,931,751 (Simonson) entitled “Collapsible Mounting for Power Saw Units” discloses a power saw which includes a support roller mounted on the feed end and a support roller mounted on the delivery end of a power saw, with the elevation of the support rollers being adjustable to provide coplanar support with the support surface of the table saw.

Other workpiece support accessories include U.S. Pat. No. 4,039,064 (Kirby) entitled “Adjustable Work Support;” and U.S. Pat. No. 4,874,025 (Cleveland) entitled “Miter Saw Utility Stand.”

### BRIEF SUMMARY OF THE INVENTION

The present invention provides a workpiece extension table with a horizontal roller for supporting oversized stock. The operator can adjust the horizontal placement of the extension table, the angle of the extended support surface, the height of the horizontal roller and the separation between the horizontal roller and workpiece support surface as required. This arrangement provides a simple and inexpensive solution to the problem of safely and efficiently cutting an over-sized piece of stock which is much longer or wider than the conventional table saw work table or bench.

The present invention provides an extension panel or table saw support surface that allows longer pieces of material and wider or thinner and more flexible material such as thin plastic laminates, plexiglass and masonite hardboard materials to be cut by one person alone. In the operation of a conventional table saw, it usually takes at least two persons, an operator and an assistant, to cut oversized stock. The operator pushes the material into the saw and guides it along the proper cut, and the assistant catches the material at the end of the table keeping it level and supporting part of the weight until the cut is complete.

One advantage of the present invention is that it eliminates the need for an assistant. The operator still pushes the material into the saw blade and guides it along the correct path. However, the present invention provides an inclined extension table to reduce friction and a roll bar to keep the stock level to allow for the operator to easily guide the material without applying extra force against the material to compensate for friction and weight of the oversized work piece. It also allows the operator to adjust the height and slope angle of the extension panel to vary the amount of friction loading on the work pieces, thus making a long cut more easily and safely.

Initially, the operator secures the workpiece support accessory to the table saw with the extension table being supported below and sloping at an angle to the saw table work surface. Additionally, the operator may be performing saw operations on a particularly wide piece of stock and can adjust the workpiece support accessory laterally so that the forward end of the stock will have balanced support. The operator then adjusts the operating height of the horizontal roller relative to the delivery and of the workpiece support accessory by securing the telescoping legs at the desired height with set screws.

The operator then prepares for saw operations on oversized stock, adjusting the horizontal placement of the workpiece support accessory, the slope angle of the extended support surface, the height of the horizontal roller and the longitudinal separation between the horizontal roller and workpiece support accessory work surface as required.

After the operator has completed all saw operations on oversized stock, the workpiece support accessory can be detached from the table saw and folded for convenient storage.

### BRIEF DESCRIPTION OF THE DRAWING

The accompanying drawing is incorporated into and forms a part of the specification to illustrate the preferred embodiments of the present invention. Various advantages and features of the invention will be understood from the following detailed description taken in connection with the appended claims and with reference to the attached drawing figures in which:

FIG. 1 is a perspective view of a table mounted power saw, showing the workpiece support accessory of the present invention;

FIG. 2 is a front elevational view of the workpiece support accessory of FIG. 1;

FIG. 3 is a side elevational view of the workpiece support accessory of FIG. 1;

FIG. 4 is a top plan view of the workpiece support accessory of FIG. 1; and

FIG. 5 is a side elevational view of the workpiece support accessory detached from the power saw table and set-up in its free-standing storage position.

### DETAILED DESCRIPTION OF THE INVENTION

A preferred embodiment of the invention will now be described with reference to various examples of how the invention can best be made and used. Like reference numerals are used throughout the description and several views of the drawing to indicate like or corresponding parts.

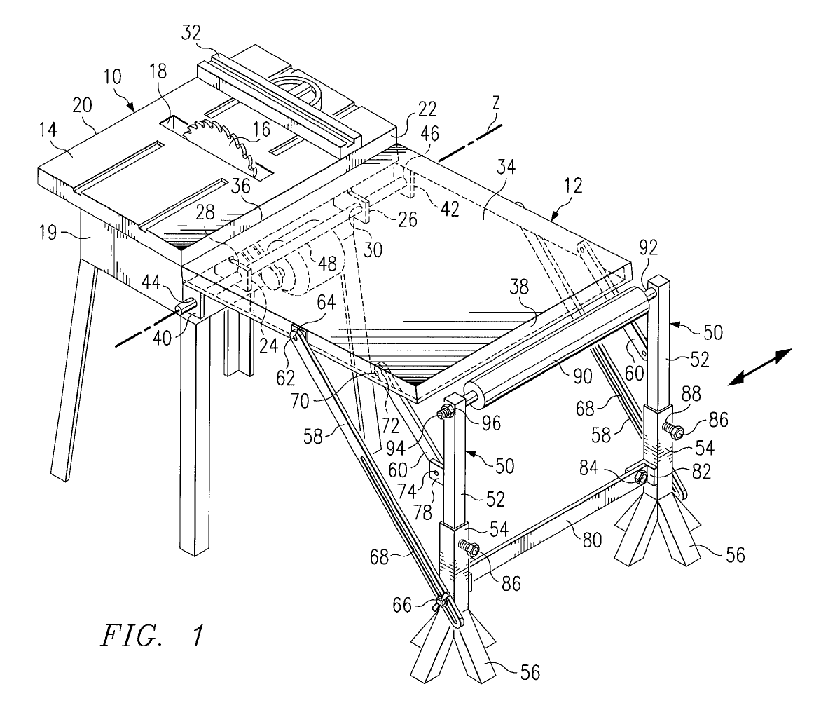

Referring to FIG. 1, a table-mounted power saw 10 with a workpiece support accessory 12 of the present invention is illustrated. The table saw 10 includes a work table 14 for supporting a conventional motor driven rotary saw blade 16. The motor driven saw blade 16 protrudes above the work table 14 through a slot 18. The work table 14 is mounted on a base 19, extending between a feed end 20 and a delivery end 22. Heavy mounting brackets 24, 26 are mounted on the delivery end 22 for attaching table saw accessories. The heavy mounting brackets 24, 26 have guide holes 28, 30. On a conventional table saw, the heavy mounting brackets are attached to the base 19 about 1″-3″ below the delivery end of the table saw work table. The table saw 10 is also equipped with a fence 32 for positioning a workpiece (not shown) as it moves across the table saw 10 from the feed end 20, to the saw blade 16, to the delivery end 22.

The workpiece support accessory 12 comprises a generally rectangular extension panel 34 having a feed end 36 and a delivery end 38. The extension panel 34 provides a sloping planar surface for supporting oversized stock (not shown) while saw operations are performed. The extension panel 34 prevents oversized stock from unexpectedly falling or shifting.

The feed end 36 of the workpiece support accessory 12 is equipped with a hinge assembly formed by heavy mounting brackets 40, 42 having holes 44, 46 for securing the workpiece support accessory 12 to the table saw 10. The workpiece support accessory 12 is secured to the base of the table saw 10 by aligning the holes 44, 46 of the heavy mounting brackets 40, 42 of the workpiece support accessory 12 with the holes 28, 30 of the heavy mounting brackets 24, 26 and inserting a crossbar 48 through the aligned holes 44, 28, 46, 30. This provides a hinged coupling which permits pivotal and horizontal movement of the extension panel relative to the work table 14.

The feed end 36 of the workpiece support accessory 12 is offset by about one to about three inches below the delivery end 22 of the table saw 10, as shown in FIG. 1 and in FIG. 3.

Referring to FIG. 1, the delivery end 38 of the workpiece support accessory 12 is supported on a pair of adjustable legs 50. Each adjustable support leg 50 includes a telescoping leg 52, a base 54 and a tripod 56.

Each adjustable support leg 50 is secured to the work surface 34 with a long side brace 58 and a short side brace 60. The long brace 58 is secured to the work surface 34 by an eye 62 and pintle 64 allowing the long brace 58 to pivot. The long brace 58 is secured to the base 54 of the adjustable support leg 50 with a secure pin 66 and a slot 68. The secure pin 66 and slot 68 allow the distance between the delivery end of the work surface 34 and adjustable support leg 50 to vary. The secure pin 66 can be manually loosened and tightened. The secure pin 66 is loosened when the distance between the work surface 34 and adjustable support leg 50 needs to be adjusted. The secure pin 66 is tightened to provide maximum support and stability.

The short brace 60 is attached to the work surface 34 by an eye 70 and pintle 72 allowing the short brace 60 to pivot. The short brace 60 is secured to the telescoping leg 52 of the adjustable support leg 50 with an eye 74 and a pintle 76 attached to a bracket 78 secured to the telescoping leg 52. The long brace 58 and short brace 60 not only connect the adjustable support legs 50 to the work surface 34 but also provide greater rigidity and stability to the structure.

Additionally, a cross beam 80 provides rigidity and stability to the workpiece support accessory 12. The cross beam 80 is secured at its ends with brackets 82 and screws 84 to the base 54 of the adjustable support legs 50.

Each base 50 and telescoping leg 52 are secured to together by a set screw 86 which frictionally engages the telescoping leg 52 through an engagement hole 88 in the base 54. The tripod 56 is attached to the base 54 and provides support to the workpiece support accessory 12. Preferably, the tripod 56 is attached to the base 54 by spot welding.

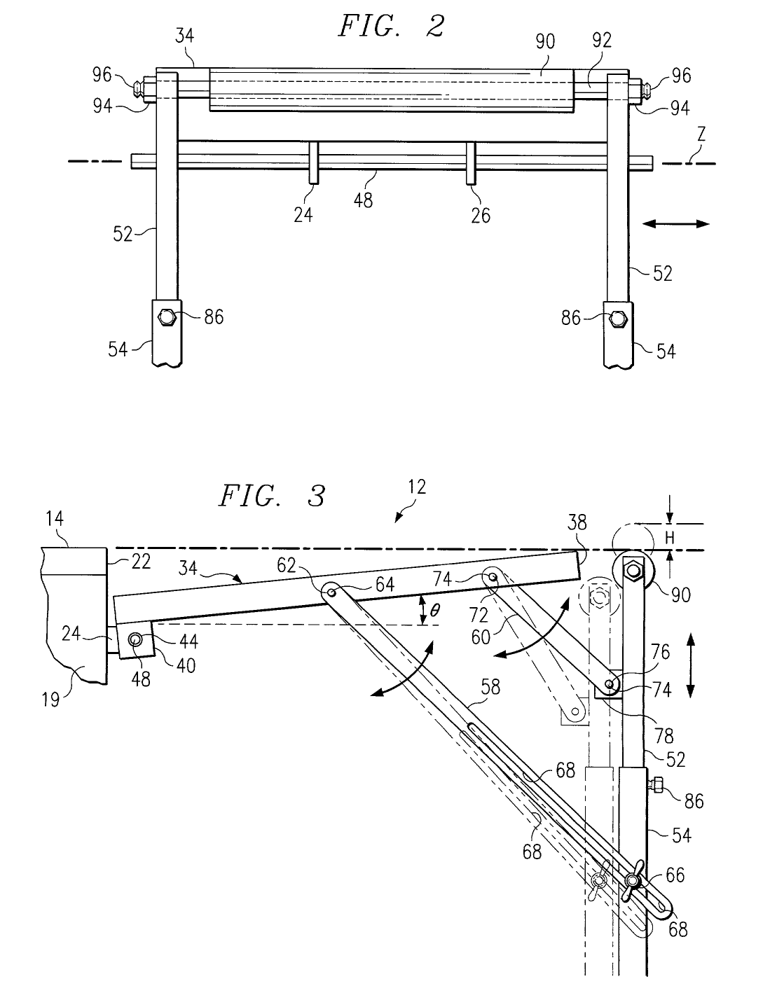

Referring to FIG. 2, a horizontal roller 90 rotates on roller bearings around a shaft 92. The shaft 92 is threaded on its opposite ends is secured to the telescoping leg 52 at each end with a nut 94 tightened around a threaded end position 96. The horizontal roller 90 can be raised or lowered relative to the work surface 34 depending on the type of saw operation being performed. The horizontal roller 90 allows the operator to easily guide the material without applying extra force against the workpiece to compensate for the friction and weight of the extended workpiece.

The operation and use of the workpiece support accessory 12 will now be described. Prior to performing a saw operation, the operator can adjust the following four variables to optimize the support and friction load on the workpiece: the lateral placement of the work surface 34, the slope angle θ of the extension panel 34, the operating height of the horizontal roller 90, and the separation distance between the horizontal roller 90 and the delivery end 38 of the work surface 34.

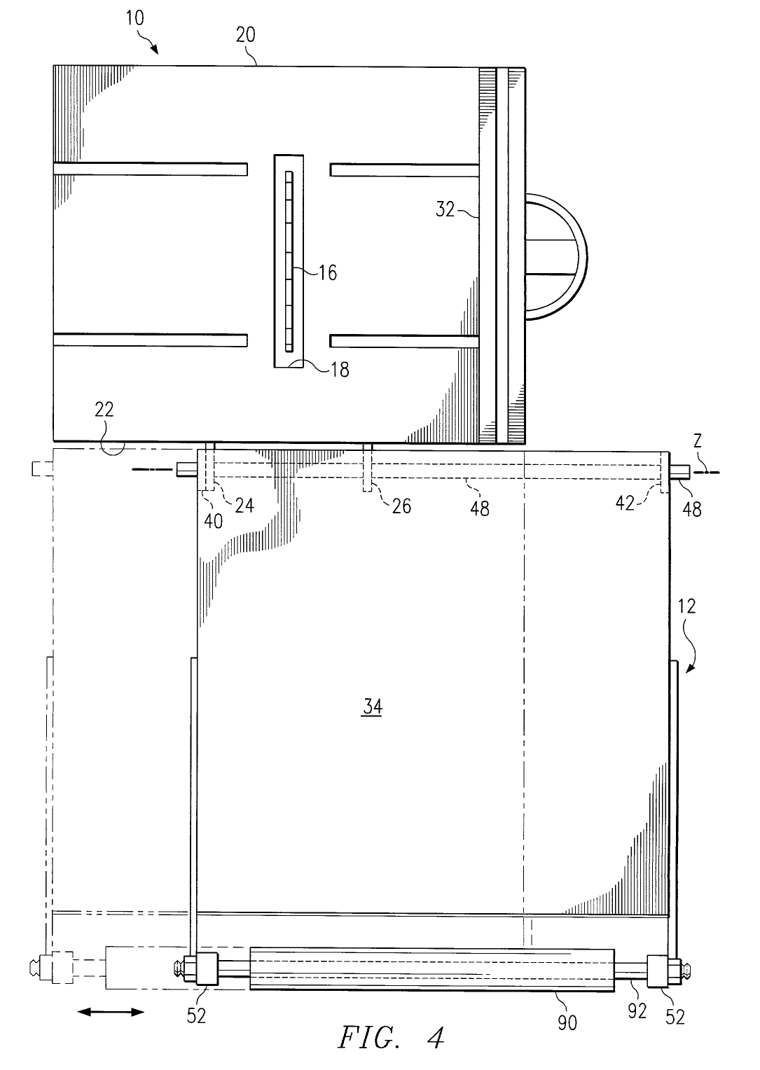

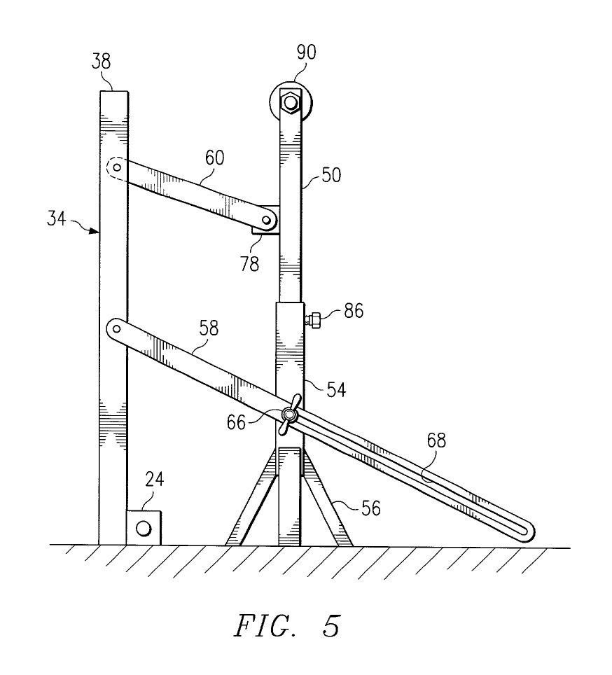

Referring to FIG. 1, FIG. 3 and FIG. 4, the operator initially secures the workpiece support accessory 12 to the base 19 of the table saw 10. The operator adjusts the horizontal placement of the workpiece support accessory 12 and the slope angle of the extension panel 34 after securing the workpiece support accessory 12 to the table saw 10 with the crossbar 48.

The operator can skew the horizontal placement of the workpiece support accessory 12, as shown in FIG. 4. If the operator is cutting a wide piece of stock, he may shift the horizontal placement of the workpiece support accessory 12 so that the extension panel 34 will provide balanced support for the stock once saw operations are begun.

As illustrated in FIG. 3, the operator can adjust the slope of the work surface 34 of the workpiece support accessory 12 by adjusting the slope angle θ, the angle of the extension panel 34 with respect to the plane of the work table 14, by pivoting the extension table about the pivot axis Z.

As illustrated in FIG. 1 and FIG. 3, the heavy mounting brackets 24,26 of the table saw 10 are attached about three inches below the table saw 10 work table 14. The workpiece support accessory 12 is pivotally coupled at its feed end and slopes upwardly toward the roller 90. By adjusting the angle θ, the angle of the work surface 34 with respect to the horizontal, the amount of friction contact between the stock and work surface 34 can be reduced.

Referring to FIG. 1, FIG. 3 and FIG. 4, the operator secures the workpiece support accessory 12 in place by running the crossbar 48 through the heavy mounting brackets 40,24,42,26. The operator then adjusts the desired horizontal displacement and slope of the extension panel 34 by shifting the panel and support legs horizontally, and pivoting the panel about the pivot axis Z. The desired panel placement is fixed by tightening the set screws 86 and secure pins 66.

After attaching the workpiece support accessory 12 to the table saw 10, the operator can adjust the spacing distance between the delivery end 38 of the extension panel 34 and the horizontal roller 90. In adjusting the spacing distance separating the panel and roller, the operator loosens the secure pin 66 of the long side brace 58, repositions the horizontal roller 90 and adjustable support leg 50 and tightens the secure pin 66 to provide maximum support and stability. The operator can adjust the spacing between the forward edge 38 of the extension panel 34 and the roller 90 by moving the tripod supports toward and away form the saw table, and by adjusting the elevation of the roller.

The operator adjusts the elevation of the horizontal roller 90 relative to the plane of the table top 14 by securing the telescoping legs 52 at the desired height with the set screws 86. The operator releases the set screws 86, raises or lowers the horizontal roller 90 and telescoping legs 52 as desired and tightens the set screws 86 in the engagement hole 88 of the base 54.

Preferably, the operator positions the extension panel 34 such that its delivery end 38 is at the same height as the work table 14. If the mounting brackets 24, 26 are three inches below the work table 14 and the extension panel is 30″ long, then the angle θ, the slope angle of the work surface 34 with respect to horizontal, is about 6°.

The sloping support surface 34 minimizes the friction between the oversized stock and the extension panel 34. While performing a saw operation with these settings, only the lead end of the oversized stock will contact the extension panel. Additionally, once the oversized stock reaches the horizontal roller 90, the horizontal roller 90 provides a frictionless or near frictionless rolling contact point for the oversized stock.

Assuming the separation distance between the horizontal roller 90 and extension panel 34 is minimum, the horizontal roller 90 height H is preferably set to be about ¼″ above the delivery end 38 of the extension panel 34, causing the lead end of the workpiece to slope slightly upward. As the workpiece feeds beyond the roller, the extended portion imposes a moment arm force on the roller that pulls the workpiece along, thus reducing the operator's pushing force burden. As the distance between the horizontal roller 90 and work surface 34 is increased, the horizontal roller 90 height is adjusted accordingly to maintain the desired height H.

The operator then prepares for saw operations on oversized stock by adjusting the horizontal placement of the workpiece support accessory 12, the slope angle of the extension panel 34, the height of the horizontal roller 90 and the separation between the horizontal roller 90 and work surface 34 as desired. The spacing of the base brackets 24, 26 relative to the panel brackets 40, 42 allows up to 12″ of horizontal shifting adjustment.

After the operator has completed all saw operations on oversized stock, he can quickly and easily detach the workpiece support accessory 12 for convenient storage. Referring to FIG. 1, the workpiece support accessory 12 is detached for storage by removing the crossbar 48 from the heavy mounting brackets 40,24,42,26, and then folding the extension panel to the upright free-standing position as shown in FIG. 5. Only removal of the crossbar is necessary; the side braces 58,60 retain the extension panel coupled to the support legs so that it can be quickly re-attached to the table saw.

Although the invention has been described with reference to certain exemplary arrangements, it is to be understood that the forms of the invention shown and described are to be treated as preferred embodiments. Various changes, substitutions and modifications can be realized without departing from the spirit and scope of the invention as defined by the appended claims.

1. An adjustable workpiece support accessory for supporting a workpiece as it is being fed across a power saw of the type including a base and a work table mounted on the base, comprising:
a) an extension panel having a feed end and a delivery end;
b) coupling apparatus connected to the extension panel and attachable to the base of a power saw for supporting movement of the extension panel relative to the power saw;
c) a pair of support legs;
d) a pair of side braces connecting the extension panel to the support legs;
e) a support shaft secured between the support legs; and
f) a roller mounted for rotation on the support shaft.

2. The adjustable workpiece support accessory of claim 1, the coupling apparatus comprising a pair of mounting brackets attachable to the power saw base, a pair of mounting brackets attached to the extension panel and a crossbar releasably engaged with the mounting brackets.

3. The adjustable workpiece support accessory of claim 1, wherein the coupling apparatus comprises hinge portions permitting pivotal movement of the extension panel relative to the power saw and slip portions permitting lateral movement of the extension panel relative to the power saw.

4. The adjustable workpiece support accessory of claim 1, wherein the coupling apparatus comprises a mounting bracket attached to the extension panel and attachable to the power saw base for supporting the feed end of the extension panel at a position that is vertically offset below the delivery end of the work table.

5. The adjustable workpiece support accessory of claim 1, the coupling apparatus comprising a hinge assembly permitting pivotal movement of the extension panel relative to the power saw.

6. The adjustable workpiece support accessory of claim 1, the coupling apparatus comprising a slip assembly permitting lateral movement of the extension panel relative to the power saw.

7. The adjustable workpiece support accessory of claim 1, wherein the feed end of the extension panel is supported at a vertically offset position below the work table and the delivery end of the extension panel is supported adjacent the roller.

8. The adjustable workpiece support accessory of claim 1, wherein the side braces are pivotally coupled to the extension panel by an eye and pintle.

9. The adjustable workpiece support accessory of claim 1, wherein each side brace is intersected by a slot and is pivotally and movably coupled to one of the adjustable support legs by a secure pin disposed in the slot.

10. The adjustable workpiece support accessory of claim 1, wherein the adjustable support legs each include a tripod.

11. The adjustable workpiece support accessory of claim 1, wherein the support legs each include an adjustable telescoping section.

12. The adjustable workpiece support accessory of claim 1, further comprising a crossbeam secured between the support legs.

13. The adjustable workpiece support accessory of claim 1, further comprising a second pair of side braces pivotally connecting the extension panel to the support legs.

14. An adjustable workpiece support accessory for supporting an oversized workpiece that is being fed through a power saw of the type having a base and a work table mounted on the base, comprising:
a) an extension panel having a feed end and a delivery end for supporting an oversized workpiece, the feed end of the extension panel being coupled to the base of the table saw for pivotal movement relative to the work table;
b) a pair of support legs;
c) a pair of side braces coupling the extension panel to the support legs;
d) a support shaft secured between the support legs; and,
e) a horizontal roller mounted for rotation on the support shaft.

15. The adjustable workpiece support accessory of claim 14, wherein the feed end of the extension panel is coupled to the base of the power saw for lateral movement relative to the work table.

16. The adjustable workpiece support accessory of claim 14, wherein the feed end of the extension panel is vertically offset below the delivery end of the work table.
